(19) United States
(12) Patent Application Publication
(10) Pub. No.: US 2012/0146339 A1
(43) Pub. Date: Jun. 14, 2012

(54) ENERGY REGENERATION DEVICE OF SUSPENSION SYSTEM FOR VEHICLE

(75) Inventor: Un Koo Lee, Seoul (KR)

(73) Assignee: Hyundai Motor Company, Seoul (KR)

(21) Appl. No.: 13/238,302

(22) Filed: Sep. 21, 2011

(30) Foreign Application Priority Data
Dec. 10, 2010 (KR) 10-2010-0126080

(51) Int. Cl. F03G 7/08

(52) U.S. Cl. 290/1 C

(57) ABSTRACT

An energy recovery device of a vehicle suspension system includes a suspension link arm that connects a wheel carrier to a subframe to move up and down according to a road condition, a rotational direction converter that is disposed between a vehicle body side connecting portion of the suspension link and a vehicle body and outputs one direction movement of both direction movements of the vehicle body side connecting portion according to the up-and-down movement of the suspension link arm, a generator that is rotated by torque outputted by the rotational direction converter to generate electrical energy, a rectifier that is connected to the generator to rectify the generated electrical energy, and a battery that is connected to the rectifier to charge the electrical energy thereto.

### CROSS-REFERENCE TO RELATED APPLICATION

This application claims priority to and the benefit of Korean Patent Application No. 10-2010-0126080 filed Dec. 10, 2010, the entire contents of which application is incorporated herein for all purposes by this reference.

### BACKGROUND OF INVENTION

1. Field of Invention

The present invention relates to an energy recovery device of a vehicle suspension system. More particularly, the present invention relates to an energy recovery device of a vehicle suspension system that is disposed on a connecting portion of a vehicle body side of a suspension link to recover up/down kinetic energy that is formed by a wheel.

2. Description of Related Art

Basically, a suspension device of a vehicle is provided with a link or links for connecting a vehicle body, it supports in a vertical direction using a chassis spring and a shock absorber, and it can modulate horizontal relative movement of a vehicle body and a wheel by modulating rigidity and flexibility.

The suspension system is required to provide a comfort characteristic by preventing irregular input of various road conditions when it is driven, and stable characteristics when it turns or brakes.

So as to satisfy the above requirements, several kinds of suspension systems have been developed to be applied to vehicles. A conventional multi-link type of suspension system related to the present invention, as shown in FIG. 1, includes a wheel carrier 4 that rotatably supports a wheel 2, and an upper side of the wheel carrier 4 is connected to a vehicle body 10 (e.g., a subframe) by a front side upper arm 6 and a rear side upper arm 8 that are disposed in a vehicle width direction, a lower side thereof is connected to the vehicle body 10 by a lower arm 12 and an assist arm 14 that are disposed in a vehicle width direction, and a trailing arm 16 that is disposed in a vehicle length direction.

Further, an upper side of the wheel carrier 4 is connected to the vehicle body through a shock absorber 18, and a spring 20 as an elastic member is interposed between the lower arm 12 and the vehicle body to reduce impact that is inputted from a road and to damp free vibration such that ride comfort is improved.

Also, an end portion of a stabilizer bar 22 that is fixed on the vehicle body side is connected to the lower arm 12 through a connecting link 24 to suppress a roll movement of the vehicle body.

A conventional multi-link type suspension system according to the above configuration relieves impact inputted from the road, reduces free vibration, and suppresses a roll of a vehicle body, however, the suspension link arm 6, 8, 12, 14, and 16 continuously repeat a “bump” and a “rebound”, and there is a problem that kinetic energy thereof is lost.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an energy recovery device of a vehicle suspension system having advantages of improving energy efficiency by recovering kinetic energy that is formed by a bump or a rebound motion of a wheel according to a driving condition.

An energy recovery device of a vehicle suspension system according to various aspects of this invention may include a suspension link arm that connects a wheel carrier to a sub frame to moves up and down according to a road condition, a rotational direction converter that may be disposed between a vehicle body side connecting portion of the suspension link and a vehicle body and outputs one direction movement of both direction movements of the vehicle body side connecting portion according to the up-and-down movement of the suspension link arm, a generator that may be rotated by the torque outputted by the rotational direction converter to generate electrical energy, a rectifier that may be connected to the generator to rectify the generated electrical energy, and a battery that may be connected to the rectifier to charge the electrical energy therein.

The rotational direction converter may include a one-way clutch.

The one-way clutch may include an inner race that rotates with a rubber bushing of a vehicle body side of the suspension link arm and an outer race that may be disposed to operate a pinion gear of the generator.

The one-way clutch may be disposed along the same axis as that of the rubber bushing, an interior gear portion that may be formed in an interior surface of the inner race may be exposed to one side at a middle portion of the rubber bushing to be gear-connected to a rotating member at which an outer gear portion may be formed, and an outer gear portion that may be formed at an exterior circumference of the outer race that may be gear-connected to an pinion gear of the generator.

The one-way clutch may be disposed to operate the generator while the suspension link arm may be being moved up (e.g., in a rebound condition).

The one-way clutch may be disposed to operate the generator while the suspension link arm may be being moved down (e.g., in a bump condition).

The one-way clutch may be built in a closed and sealed housing.

The suspension link arm may be one type of arms that connect a wheel carrier to a vehicle body to realize a link function in a multi-link type suspension.

The suspension link arm may be one type of arms that connects a wheel carrier to a vehicle body to realize a link function in a MacPherson type, a dual-link type, or a double wishbone type of suspension.

In an energy recovery device of a vehicle suspension system according to various aspects of the present invention, an energy recovery device may be disposed between a connecting portion of a suspension link vehicle body side and a vehicle body to transform kinetic energy of a bump or a rebound that may be generated in a wheel to a rotation movement, wherein the energy recovery device transforms kinetic energy that may be formed by up-and-down movement of the suspension link arm to electrical energy, and the electrical energy may be rectified through a rectifier to be charged in a battery such that energy efficiency thereof may be improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 shows an example of a general multi-link suspension system.

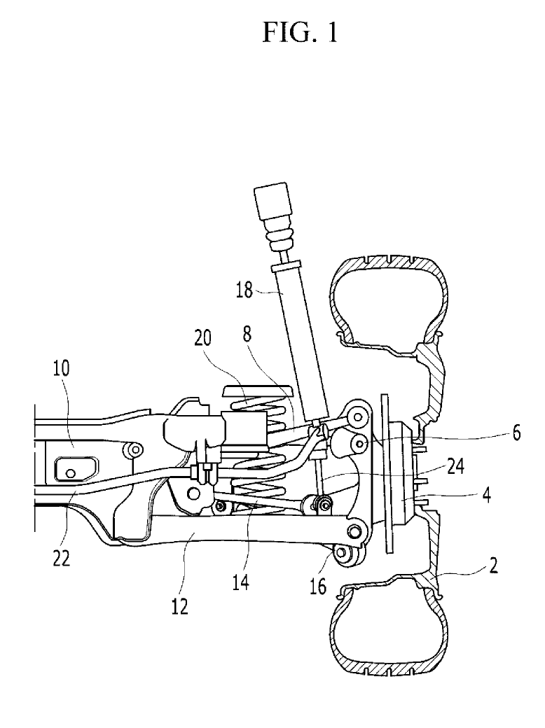

FIG. 2 is a perspective view of an exemplary energy recovery device according to various embodiments of the present invention.

FIG. 3 is a partial exploded perspective view and a partial sectional perspective view according to various embodiments of the present invention.

FIG. 4 is an exploded perspective view of an exemplary energy recovery device according to various embodiments of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Portions having no relation to the description will be omitted in order to explicitly explain the present invention, and the same reference numerals will be used for the same or similar elements throughout the specification.

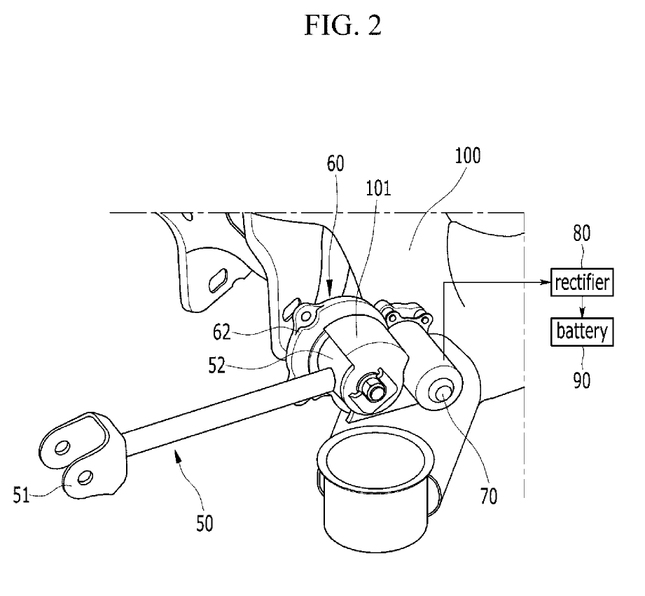

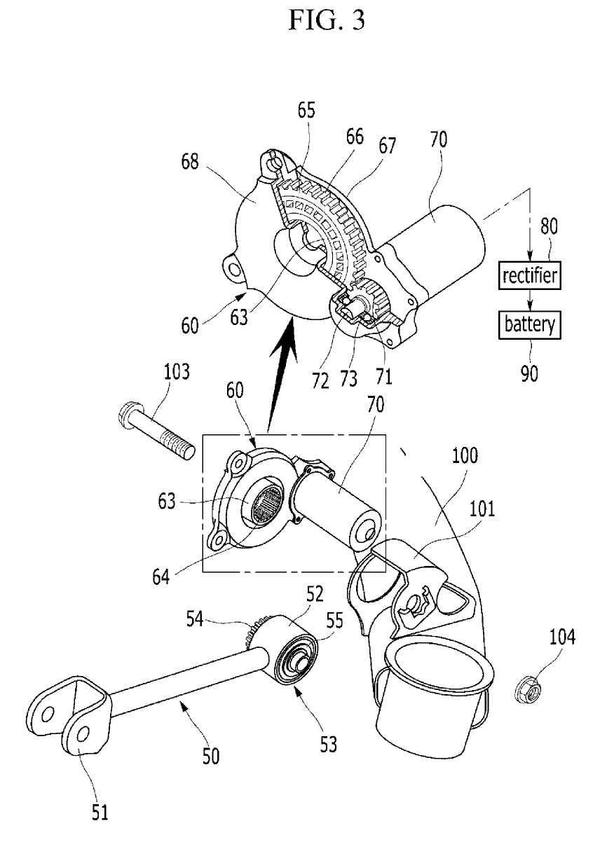

FIG. 2 and FIG. 3 show a mounting condition of an energy recovery device according to various embodiments of the present invention, and the energy recovery device according to the present exemplary embodiment includes a suspension link arm 50, a rotational direction converter 60, a generator 70, a rectifier 80, and a battery 90.

In the above, the suspension link arm 50 designates all links that connect a wheel carrier to a vehicle body 100 (e.g., subframe) to move up and down according to a road condition.

Here, the energy recovery device according to the present exemplary embodiment can be applied to a multi-link type of suspension system, but it is not limited thereto.

That is, the suspension link arm 50 can be applied to all arms that perform a link function to connect a wheel carrier to a vehicle body in all suspension systems that include a multi-link type, a MacPherson type, a dual-link type, and a double wishbone type.

The rotational direction converter 60 transforms both direction movements of the connecting portion 52 of the vehicle body side according to the up-and-down movement of the suspension link arm 50 to one direction movement to output it.

The generator 70 is rotated by one-way direction torque that is inputted by the rotational direction converter 60 to generate electrical energy.

The rectifier 80 is electrically connected to the generator 70 to rectify the electricity that is formed by the generator 70.

The battery 90 is electrically connected to the rectifier to store the electrical energy.

More specifically, the suspension link arm 50 is a link member having a predetermined length, a wheel side connecting portion 51 and a vehicle body side connecting portion 52 are formed at both sides thereof, the wheel side connecting portion 51 is connected to a wheel carrier through a rubber bushing, the vehicle body side connecting portion 52 is connected to a bracket 101 of the vehicle body 100 through a bolt 103 and a nut 104, wherein a rubber bushing 53 is interposed therebetween.

Accordingly, the wheel side connecting portion 51 moves up and down based on a hinge of the vehicle body side connecting portion 52 during a bump and a rebound and the up-and-down movement is suppressed by elastic force of the rubber bushing 53 in the vehicle body side connecting portion 52.

Further, a rotating member 55 in which an outer gear portion 54 is formed at an exposed exterior circumference of one side part is disposed at a middle portion of the rubber bushing 53 to transfer the up-and-down direction torque to the rotational direction converter 60.

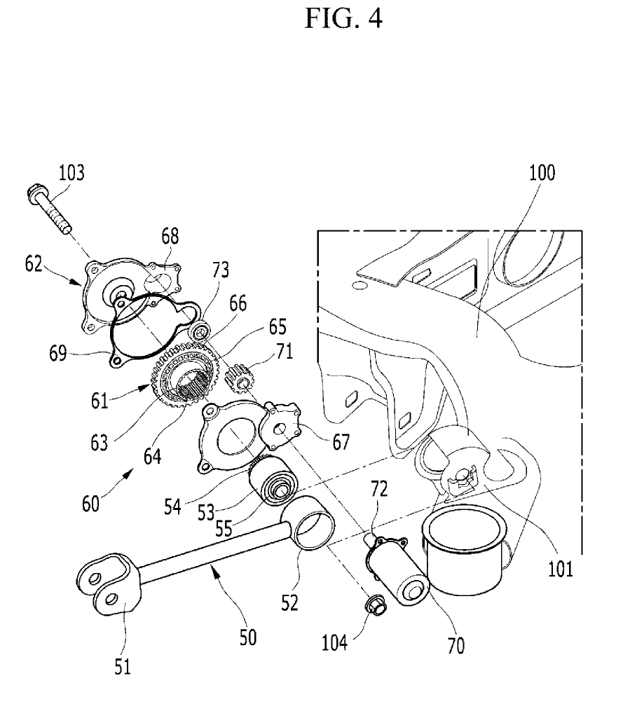

As shown in FIG. 4, the rotational direction converter 60 includes a one-way clutch 61 that is built in a housing 62 including left and right cases, and grease as a lubrication member is charged into the housing 62.

The one-way clutch 61 is disposed along the same axis as that of the rubber bushing 53, an interior gear portion 64 is formed in an interior surface of an inner race 63 to be engaged with the outer gear portion 54 of the rotating member 55, and an outer gear portion 66 is formed at an exterior circumference of an outer race 65 to be engaged with a pinion gear 71 of the generator 70.

The one-way clutch 61 allows only the inner race 63 to rotate in a bump behavior and allows the outer race and the inner race 63 to rotate together in a rebound behavior, or allows only the inner race to rotate in a rebound behavior and allows the outer race and the inner race 63 to rotate together in a bump behavior.

The generator 70 is disposed at one side of the housing 62, a rotation shaft 72 of the generator 70 penetrates one side of a case 67 of the housing 62 to be connected to the pinion gear 71, and a bearing 73 is rotatably interposed between one end of the rotation shaft 72 and a case 68.

Accordingly, while the suspension link arm 50 repeats a bump or a rebound according to a road condition, the rotating member 55 of the rubber bushing 53 transfers the torque to the inner race 63 of the one-way clutch 60.

Thus, the one-way clutch 61 does not transfer a rotation movement at a bump behavior and only transfers the rotation movement at a rebound behavior, or does not transfer a rotation movement at a rebound behavior and only transfers the rotation movement at a bump behavior according to a mounting direction of the one-way clutch 61 such that the generator 70 rotates in one side direction to generate electrical energy.

The electrical energy of the generator 70 is rectified by the rectifier 80 to be stored in the battery 90.

That is, the kinetic energy according to a movement of the vehicle is recovered by electrical energy to improve energy efficiency.

The energy recovery device that is operated as stated above is applied to a vehicle body side connecting portion of all kinds of arms that connect a wheel carrier to a vehicle body to transform kinetic energy thereof into electrical energy, wherein the arm includes all suspension link arms that move up and down according to a road condition regardless of the suspension system, which can be a multi-link type, a MacPherson type, a dual-link type, and a double wishbone type.

It is described that the rotational direction converter 60 is one-way clutch 61 in the present invention, but it is not limited thereto, and all elements that can transfer an up-and-down movement to a rotation of a shaft can be applied thereto.

Element number 69 of FIG. 4 designates a gasket that is interposed between both cases 67 and 68 to prevent the grease that is filled in the housing 62 from leaking.

For convenience in explanation and accurate definition in the appended claims, the terms upper or lower, front or rear, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An energy recovery device of a vehicle suspension system, comprising:
a suspension link arm connecting a wheel carrier to a subframe to move up and down according to a road condition;
a rotational direction converter disposed between a vehicle body side connecting portion of the suspension link and a vehicle body that converts opposing directional movements of the vehicle body side connecting portion according to the up-and-down movement of the suspension link arm into one directional rotational movement;
a generator rotated by one directional rotation movement of the rotational direction converter to generate electrical energy;
a rectifier connected to the generator to rectify the generated electrical energy; and
a battery connected to the rectifier to store the generated electrical energy therein.

2. The energy recovery device of claim 1, wherein the rotational direction converter includes a one-way clutch.

3. The energy recovery device of claim 1, wherein the one-way clutch includes an inner race rotating with a rubber bushing of a vehicle body side of the suspension link arm and an outer race disposed to operate a pinion gear of the generator.

4. The energy recovery device of claim 3, wherein the one-way clutch is disposed coaxial with the rubber bushing, an interior gear portion formed in an interior surface of the inner race is exposed to one side at a middle portion of the rubber bushing to be gear-connected to a rotating member at which an outer gear portion is formed, and an outer gear portion formed at an exterior circumference of the outer race that is gear connected to an pinion gear of the generator.

5. The energy recovery device of claim 3, wherein the one-way clutch is disposed to operate the generator while the suspension link arm is being moved upward or in a rebound condition.

6. The energy recovery device of claim 3, wherein the one-way clutch is disposed to operate the generator while the suspension link arm is being moved downward or in a bump condition.

7. The energy recovery device of claim 3, wherein the one-way clutch is built in a closed and sealed housing.

8. The energy recovery device of claim 1, wherein the suspension link arm is one type of arms that connect a wheel carrier to a vehicle body to realize a link function in a multi-link type suspension.

9. The energy recovery device of claim 1, wherein the suspension link arm is one type of arms that connects a wheel carrier to a vehicle body to realize a link function in a MacPherson type, a dual-link type, or a double wishbone type of suspension.
